(19) United States
(12) Patent Application Publication
(10) Pub. No.: US 2023/0254796 A1
(43) Pub. Date: Aug. 10, 2023

(54) RESOURCE CONFIGURATION USING THE BURST SPREAD PARAMETER FOR WIRELESS COMMUNICATION SYSTEMS

(71) Applicant: ZTE Corporation, Shenzhen (CN)

(72) Inventors: Jie TAN, Shenzhen (CN); Xiubin SHA, Shenzhen (CN); Bo DAI, Shenzhen (CN); Ting LU, Shenzhen (CN)

(21) Appl. No.: 18/300,833

(22) Filed: Apr. 14, 2023

Related U.S. Application Data
(63) Continuation of application No. PCT/CN2020/121205, filed on Oct. 15, 2020.

(51) Int. Cl. H04W 56/00

(52) U.S. Cl. CPC H04W 56/0045; H04W 56/0015

(57) ABSTRACT

Methods, systems, and devices for resource configuration using the burst spread parameter in mobile communication technology are described. An example method for wireless communication includes receiving, by a wireless device from a network node, a configuration for a pre-configured group of semi-persistent scheduling (SPS) resources with a bundling relationship. Another example method for wireless communication includes receiving, by a wireless device from a network node, a value based on a propagation delay of a wireless channel between the network node and a wireless device, and performing, based on the value of the propagation delay, a propagation delay compensation operation.

### CROSS-REFERENCE TO RELATED APPLICATIONS

This application is a continuation of International Patent Application No. PCT/CN2020/121205, filed on Oct. 15, 2020, the contents of which are incorporated herein by reference in their entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques will provide support for an increased number of users and devices, as well as support for higher data rates.

### SUMMARY

This document relates to methods, systems, and devices for resource configuration using the burst spread parameter in mobile communication technology, including 5th Generation (5G) and New Radio (NR) communication systems. In an example, the burst spread parameter is introduced into the radio access network (RAN) specification, which advantageously mitigates the data transmission delay problem caused by jitter.

In one exemplary aspect, a wireless communication method is disclosed. The method includes receiving, by a wireless device from a network node, a configuration for a pre-configured group of semi-persistent scheduling (SPS) resources with a bundling relationship.

In another exemplary aspect, a wireless communication method is disclosed. The method includes transmitting, by a network node to a wireless device, a configuration of a pre-configured group of semi-persistent scheduling (SPS) resources with a bundling relationship.

In yet another exemplary aspect, a wireless communication method is disclosed. The method includes determining, by a network node, a propagation delay of a wireless channel between the network node and a wireless device, and transmitting, to the wireless device, a value based on the propagation delay.

In yet another exemplary aspect, a wireless communication method is disclosed. The method includes receiving, by a wireless device from a network node, a value based on a propagation delay of a wireless channel between the network node and a wireless device, and performing, based on the value of the propagation delay, a propagation delay compensation operation.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a base station (BS) and user equipment (UE) in wireless communication, in accordance with some embodiments of the presently disclosed technology.

FIG. 2 shows an example of semi-persistent scheduling (SPS) resource groups and the jitter in a wireless channel.

FIG. 3 shows an example of a message flow for indicating that an SPS resource group is configured only for packets belonging to the same QoS flow.

FIG. 4 shows an example of a message flow for a deactivation indication in a pre-defined downlink control information (DCI) transmission.

FIG. 5 shows an example of a message flow for updating resources when the burst spread parameter changes.

FIG. 6 shows an example of a message flow for calculating and transmitting the propagation delay from the network node to the wireless device.

FIGS. 7 and 8 show examples of MAC CE formats for fixed granularity.

FIGS. 9 and 10 show examples of MAC CE formats for variable granularity.

FIG. 11 shows an example of a message flow for calculating and transmitting the propagation delay to configure the wireless device to perform propagation delay compensation.

FIG. 12 shows an example of a message flow for transmitting reference time information to configure the wireless device to perform propagation delay compensation.

FIGS. 13-16 show examples of wireless communication methods.

FIG. 17 is a block diagram representation of a portion of an apparatus in which the disclosed techniques may be implemented.

### DETAILED DESCRIPTION

In the New Radio (NR) access standard, a burst spread parameter is introduced in the application layer to avoid data transmission delays caused by jitter during Time-Sensitive Network (TSN) quality of service (QoS) transmissions. In some implementations, the burst spread is sent by the Policy Control Function (PCF) to the Session Management Function (SMF), which uses it to determine a burst spread Time Sensitive Communications (TSC) Assistance Information (TSCAI) parameter. When scheduling packets on different bridges, a particular packet is scheduled after other higher priority packets that are received, e.g. from other ports, at each bridge. This behavior creates a jitter on the (periodic) packet arrival time of a TSN flow, in the cycle time, and configured for this TSN flow. Alternatively, this jitter is generated when downlink data is sent on the N6 (interface between the Data Network (DN) and the User Plane Function (UPF)), which affects the data arrival time. Embodiments of the disclosed technology overcome the aforementioned TSN QoS transmission jitter and other potential jitter sources by configuring SPS resources based on the burst spread parameter.

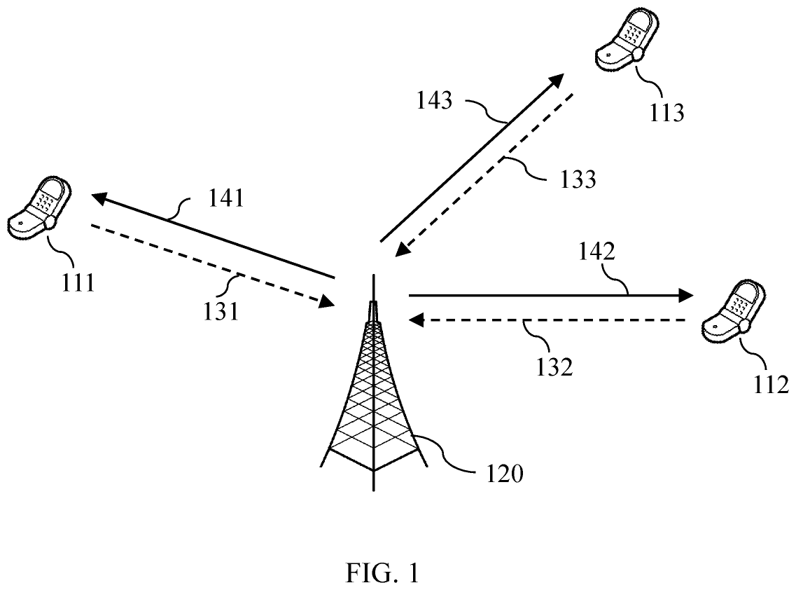

FIG. 1 shows an example of a wireless communication system (e.g., an LTE, 5G or New Radio (NR) cellular network) that includes a BS 120 and one or more user equipment (UE) 111, 112 and 113. In some embodiments, the downlink transmissions (141, 142, 143) include a configurations of pre-configured SPS resources. The UE may be, for example, a smartphone, a tablet, a mobile computer, a machine to machine (M2M) device, a terminal, a mobile device, an Internet of Things (IoT) device, and so on.

The present document uses section headings for ease of understanding and do not limit the embodiments and techniques to the corresponding sections. As such, embodiments from one section can be combined with embodiments from other sections. Furthermore, the present document uses examples from the 3GPP New Radio (NR) network architecture and 5G protocol only to facilitate understanding and the disclosed techniques and embodiments may be practiced in other wireless systems that use different communication protocols than the 3GPP protocols.

1. Examples of Preconfiguring Multiple Continuous SPS Resources

In some embodiments, the gNB needs to pre-configure multiple continuous semi-persistent scheduling (SPS) resources for the UE. However, not all resources need to be utilized. These embodiments optimize the pre-configuration of multiple continuous SPS resources based on the principle of resource saving.

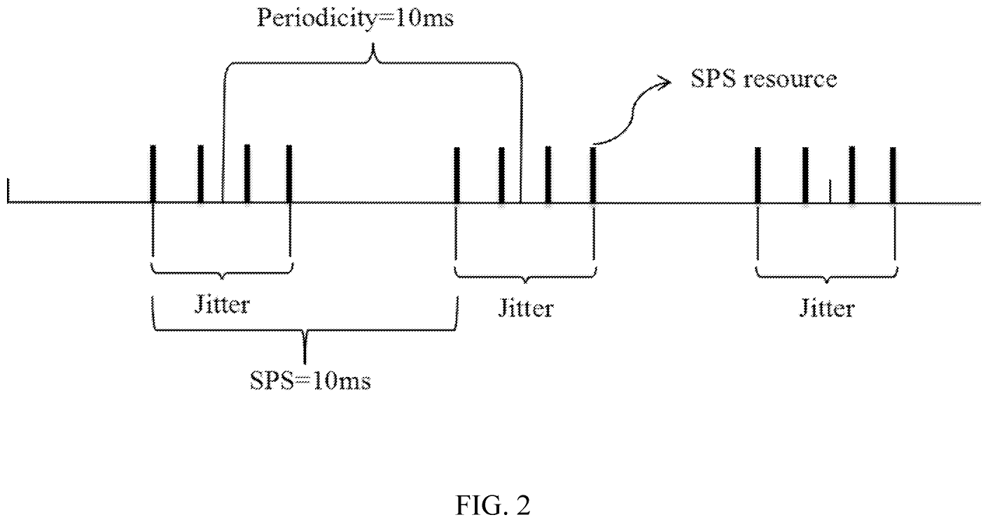

In an example, the multiple consecutive SPS resources can be configured based on the transmission period and burst spread in the same QoS flow. Thus, multiple SPS groups can be pre-configured through BWP-DownlinkDedicated, wherein the UE receives a configuration from the gNB for a preconfigured set of semi-persistent scheduling (SPS) resources with a bundling relationship. The bundling relationship comprises a subset of the pre-configured group of SPS resources for a same service within a time window in a transmission cycle, a subset of the pre-configured group of SPS resources for a same logical channel, or a subset of the pre-configured group of SPS resources for the same service. Each SPS group is pre-configured on the corresponding physical channel and has the same priority during data transmission. As shown in the example in FIG. 2, when both the service data transmission period and SPS scheduling period are 10 ms and the value of burst spread is 4 ms, four consecutive SPS resources are pre-configured in the SPS group.

As shown in FIG. 2, the range of each SPS group is larger than or equal to the range of burst spread. In an example, a hybrid automatic repeat request (HARD) process number value in the downlink control information (DCI) format indicates the start position of the SPS in the SPS group to be activated, and a 3-bit field can be used to indicate the number of SPS activated continuously in the SPS group.

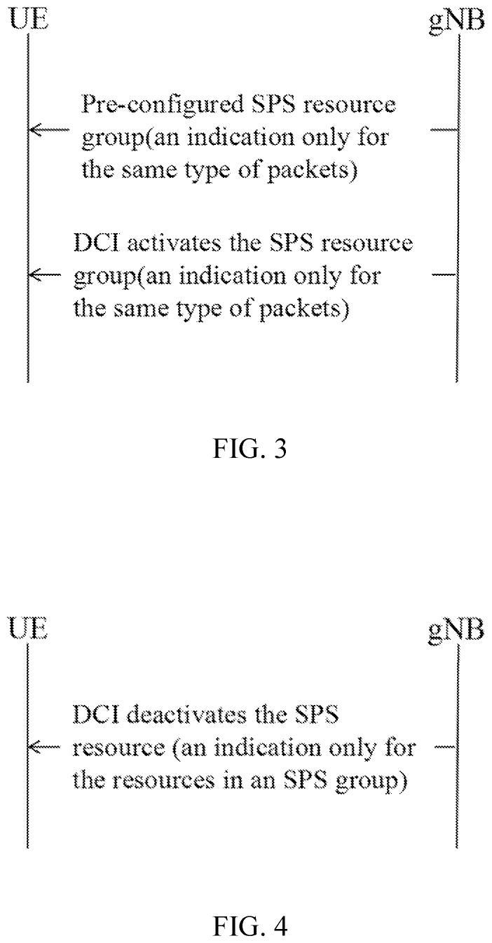

In this example, the UE receives a packet in a pre-configured SPS resource group, but does not receive other packets in the SPS resource group. Herein, the gNB provides an indication to the UE that the SPS resource group is only for packets of the same QOS flow. A shown in FIG. 3, this indication contains at least one of the following:

(1) When the SPS resource group is pre-configured, it contains an indication only for the same type of packets; and

(2) When the DCI activates the SPS resource group, it contains an indication only for the same type of packets.

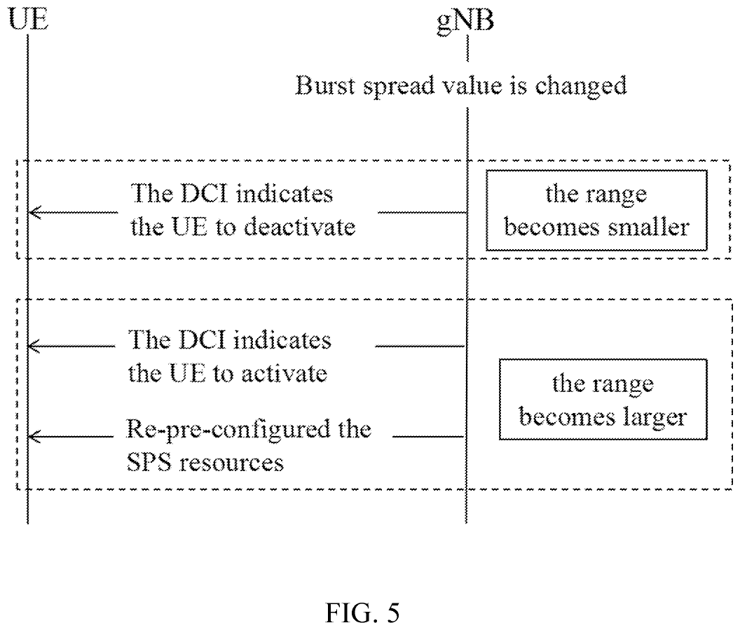

In some embodiments, when the UE has received packets of the same QOS flow on the activated SPS resource group or the gNB has no packet to be sent in the current time window, the UE needs to know that no packets of the same type need to be received in the current period before releasing the SPS resources in this time window. In this case, the gNB provides an indication to the UE to deactivate the activated SPS resource in the current time window through the deactivated DCI. The value of HARQ process number or index in the DCI indicates the start position of the SPS in the SPS group to be deactivated, and the DCI contains an indication for deactivation within the group. This explicit indication is only applicable to the release of SPS resources in an SPS resource group. In this case, when UE receives the gNB in one or more resources of the configured group of SPS resources in the time window, the UE releases the some or all other SPS resources in the current time window. This implicit indication is only applicable to the release of SPS resources in an SPS resource group, and an example of the pre-defined DCI is shown in FIG. 4.

2. Examples of the Burst Spread Parameter Changing

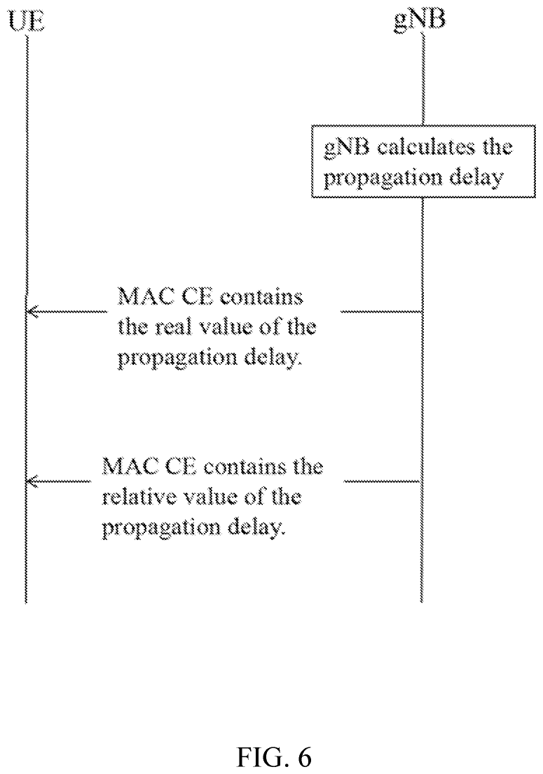

In some embodiments, if the burst spread in the same service of the TSN is changed, the pre-configured SPS resources are updated to meet the downlink scheduling requirement. The value of the burst spread (or alternatively, the range of the burst spread value) may increase or decrease, as shown in FIG. 5.

In the case when the range of the burst spread value becomes smaller, the HARQ process number value or index value in the deactivated DCI format indicates the starting position of the remaining activated SPS resources after some SPS resources in the SPS group are deactivated. In an example, a 3-bit field is used to indicate the number of remaining continuously activated SPS resources in the SPS group.

In the case when the range becomes larger, the operations performed depend on whether the SPS resources have been pre-configured or not. If the larger burst spread value can be handled in the pre-configured SPS resource group (i.e., the SPS resources have been pre-configured), the HARQ process number value or index value in the activated DCI format indicates the starting position of the SPS in the activated SPS group, and a 3-bit field is used to indicate the number of continuously activated SPSs in the SPS group. However, if the larger value of the burst spread parameter is not included in the pre-configured SPS resource group (e.g., the SPS resources have not been pre-configured), the SPS resource group is reconfigured through gNB (e.g., Radio Resource Control (RRC) Reconfiguration information), and DCI is used to indicate the UE to activate the SPS resource.

3. Examples of Measuring the Propagation Delay Using RTT or a Large SCS

In some embodiments, the propagation delay between the network node and the wireless device can be measured by using the round-trip time (RTT) method or by using a large subcarrier spacing (SCS). A large subcarrier spacing corresponds to the UE using a small subcarrier spacing (15 kHz, 30 kHz or 60 kHz) to transmit service information, and the gNB measuring the uplink signals of the UE using a large subcarrier spacing (120 kHz or 240 kHz) to obtain the propagation delay value.

When the propagation delay is measured by using the RTT method or the large subcarrier spacing, at least one of the following conditions should be satisfied:
Initial access;
The UE requesting the reference time information;
After the gNB sends the indication information, the indication information indicates at least one of the following operations: the UE performs a propagation delay compensation (PDC) operation or the UE performs propagation delay measurement; and
Performing periodic measurements based on the clock update period requested by the UE.

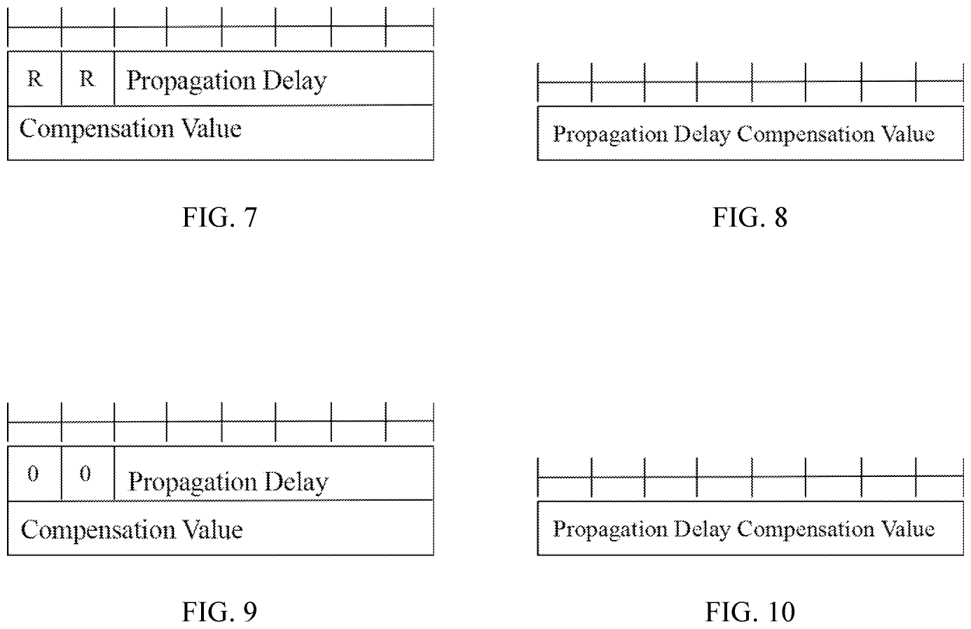

As shown in FIG. 6, when the gNB calculates the propagation delay and UE performs propagation delay compensation (PDC), the gNB sends the measurement value of the propagation delay to the UE. In an example, the granularity of the measurement value can be fixed or variable.

In this embodiments, a fixed granularity is characterized by at least one of the following:
The value is in nanoseconds; and
The value is determined by multiplying the Timing Advance (TA) value of a predefined SCS (e.g., 15 kHz) by different factors. In an example, this factor is ½, ¼, ⅛, or 1/16.

In this embodiments, a variable granularity is characterized by at least one of the following:
A granularity group is composed of multiple values in nanoseconds; and
The granularity group is composed of multiple different granularities that are determined by multiplying the TA values corresponding to a predefined SCS (e.g., 15 kHz) by different factors. In an example, this factor is ½, ¼, ⅛, or 1/16.

If the granularity of the measured value is variable, an indication indicating the granularity of the current measurement value should be included when sending the measurement value of the propagation delay.

In some embodiments, at least one of the following conditions are included to trigger the gNB to send the measured value:
gNB identifies that the current UE needs to perform propagation delay compensation;
gNB receives the reference time request;
gNB satisfies the condition of periodically sending the clock information; and
gNB identifies that the difference between the measured value and the last transmitted value is about to be greater than the maximum relative value.

In some embodiments, at least one of the following are used by gNB to transmit the measured value:
The true value of propagation delay measurement is always sent; and
gNB sends the relative value of propagation delay measurement after the true value is sent, where the relative value is calculated based on the real value of the previous transmission.

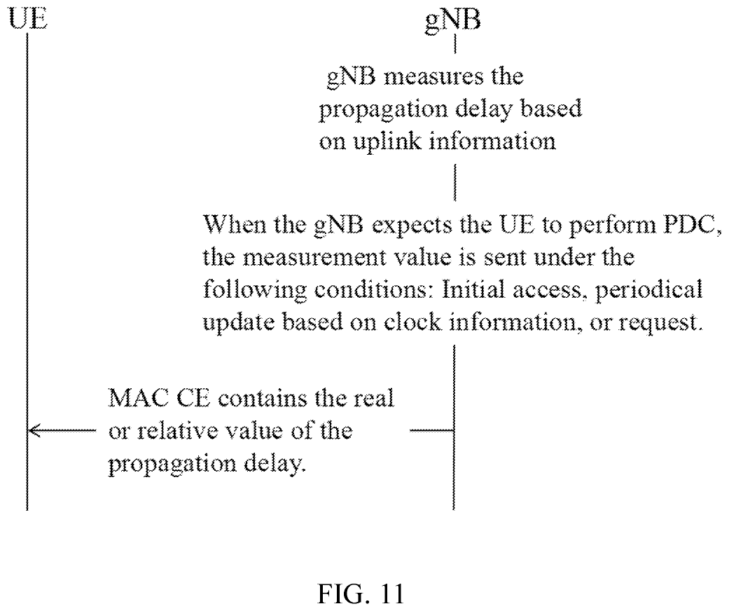

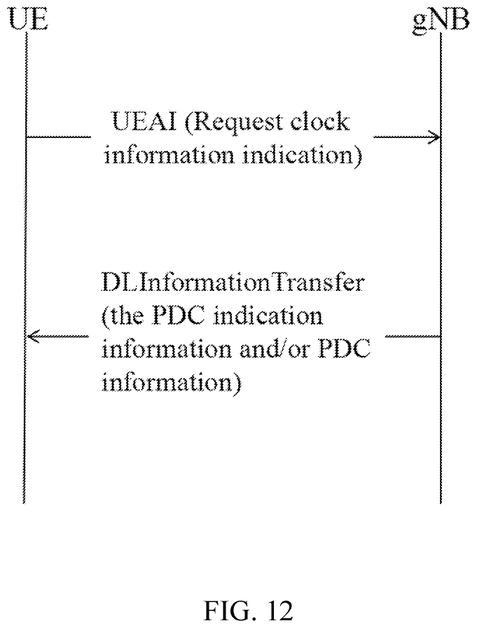

In this case, the real value or relative value is transmitted through the predefined MAC CE, and the Logical Channel ID (LCID) reserved value in the DL-SCH that indicates the predefined MAC CE format. In an example, for the fixed granularity case, the MAC CE formats of the real value and relative value (in 10 ns units) are shown in FIG. 7 and FIG. 8, respectively. In another example, for the variable granularity case, the MAC CE formats of the real value and relative value (in 10 ns units) are shown in FIG. 9 and FIG. 10, respectively. In FIG. 9, “00” means the current granularity is 10 ns.

4. Examples of Different Granularities for Propagation Delay Measurements

In some embodiments, when the UE uses a small subcarrier spacing (15 kHz, 30 kHz or 60 kHz) to transmit service information, the gNB measures the uplink signals of the UE through this subcarrier spacing. The gNB calculates a TA value with a smaller granularity or a propagation delay compensation value based on the measurement.

In these embodiments, the granularity of the measurement value can be fixed (e.g., as shown FIGS. 7 and 8) or variable (e.g., as shown in FIGS. 9 and 10).

In this embodiments, a fixed granularity is characterized by at least one of the following:
The value is in nanoseconds; and
The value is determined by multiplying the Timing Advance (TA) value of a predefined SCS (e.g., 15 kHz) by different factors. In an example, this factor is ½, ¼, ⅛, or 1/16

In this embodiments, a variable granularity is characterized by at least one of the following:
A granularity group is composed of multiple values in nanoseconds; and
The granularity group is composed of multiple different granularities that are determined by multiplying the TA values corresponding to a predefined SCS (e.g., 15 kHz) by different factors. In an example, this factor is ½, ¼, ⅛, or 1/16.

If the granularity of the measured value is variable, an indication indicating the granularity of the current measurement value should be included when sending the measurement value of the propagation delay.

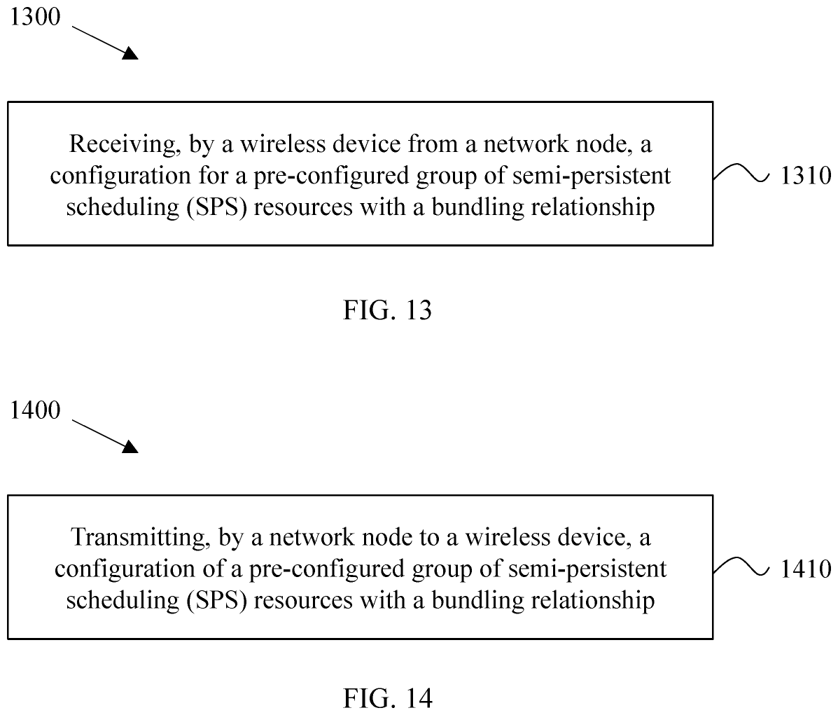

In some embodiments, as shown in FIG. 11, at least one of the following conditions are included to trigger the gNB to send the measured value:
Initial access;
gNB identifies that the current UE needs to perform PDC;
gNB receives the reference time request;
gNB satisfies the condition of periodically sending the clock information; and
gNB identifies that the difference between the measured value and the last transmitted value is about to be greater than the maximum relative value.

In some embodiments, after the gNB obtains the TA value with a smaller granularity or a PDC value, the gNB sends measurement values using one of the following methods:
The gNB transmits the PDC information through the predefined MAC CE. The LCID reserved value in the DL-SCH indicates the predefined MAC CE format that contains the PDC information. The PDC information includes a PDC value and/or TA with a smaller granularity. Based on the size of the bit-field occupied by the MAC CE, the UE can distinguish between the real value and relative value of the PDC.
The gNB transmits the PDC information through the extended MAC RAR and extended Timing Advance Command MAC CE. The PDC information contains the TA with a smaller granularity. In the case of variable granularity, the RRC message indicates the granularity of the TA value, and contains at least one of the following: RRCReestablishment, RRCReconfiguration, RRCResume, RRCReject, and RRCSetup.

5. Examples of Performing Propagation Delay Compensation

In some embodiments, when the UE has PDC capability, the gNB determines whether the reference time information that needs to be sent to the UE needs to be PDC. Furthermore, based on the result of the determination, the gNB transmits an indication to the UE that signals whether to perform the PDC.

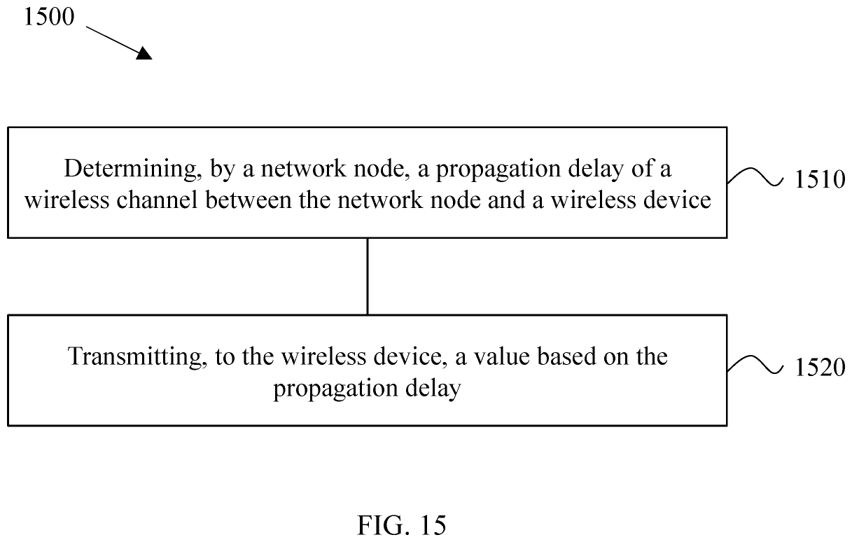

As shown in FIG. 12, when the UE sends the UE Assistance Information (UEAI) containing a request for time information to the gNB, the gNB sends the reference time information to the UE through unicast or broadcast, and indicates whether the UE should perform the PDC operation.

In the case of unicast transmitting time information, the gNB sends to the UE a message indicating whether to perform the PDC. If the message indicates that the UE should perform the PDC operation, the UE uses the actual measurement value to compensate for the time information. Herein, gNB should further provide the PDC information, which at least includes one of the following: updated TA value, TA with a smaller granularity, PDC value, and a valid TA value with a large subcarrier spacing.

In this example, the above information requires the UE to receive the PDC indication information and/or PDC information, and they can be received using either the DLlnformationTransfer message or the ReferenceTimelnfo field.

6. Example Methods and Implementation of the Disclosed Technology

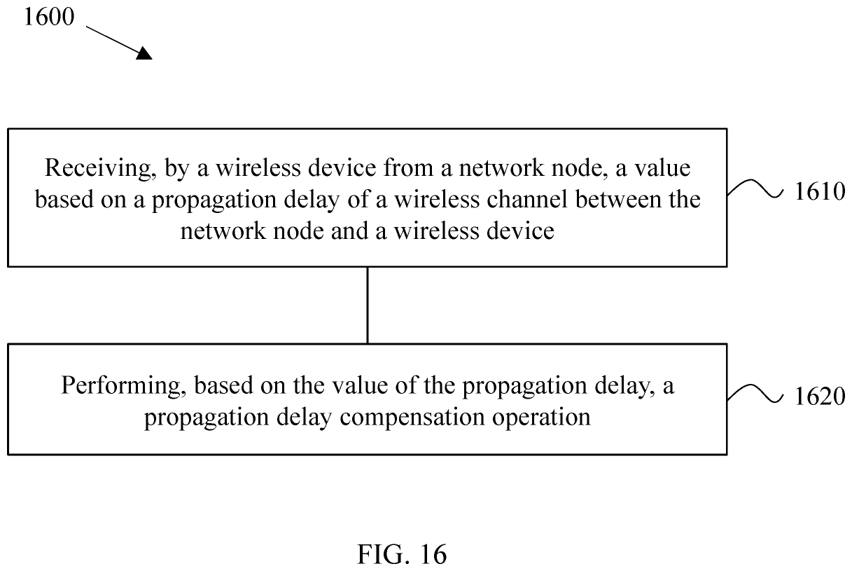

FIG. 13 shows an example of a wireless communication method 1300. The method 1300 includes, at operation 1310, receiving, by a wireless device from a network node, a configuration for a pre-configured group of semi-persistent scheduling (SPS) resources with a bundling relationship.

FIG. 14 shows an example of a wireless communication method 1400. The method 1400 includes, at operation 1410, transmitting, by a network node to a wireless device, a configuration of a pre-configured group of semi-persistent scheduling (SPS) resources with a bundling relationship.

FIG. 15 shows an example of a wireless communication method 1500. The method 1500 includes, at operation 1510, determining, by a network node, a propagation delay of a wireless channel between the network node and a wireless device.

The method 1500 includes, at operation 1520, transmitting, to the wireless device, a value based on the propagation delay.

FIG. 16 shows an example of a wireless communication method 1600. The method 1600 includes, at operation 1610, receiving, by a wireless device from a network node, a value based on a propagation delay of a wireless channel between the network node and a wireless device.

The method 1600 includes, at operation 1620, performing, based on the value of the propagation delay, a propagation delay compensation operation.

Embodiments of the disclosed technology provide the following technical solutions for resource configuration using the burst spread parameter, which mitigate the data transmission delay problems caused by jitter.

S1. A method for wireless communication, comprising receiving, by a wireless device from a network node, a configuration for a pre-configured group of semi-persistent scheduling (SPS) resources with a bundling relationship.

S2. The method of solution S1, wherein the bundling relationship comprises a subset of the pre-configured group of SPS resources for a same service within a time window in a transmission cycle, a subset of the pre-configured group of SPS resources for a same logical channel, or a subset of the pre-configured group of SPS resources for the same service.

S3. The method of solution S1, further comprising receiving an activation indication for at least one resource of the pre-configured group of SPS resources, receiving, subsequent to receiving the activation indication, a deactivation indication for one or more SPS resources in a time window, and releasing, based on the deactivation indication, the one or more SPS resources in the time window.

S4. The method of solution S1, further comprising receiving, from the network node, a transmission in one or more SPS resources, and releasing, based on receiving the transmission in a time window, some or all other SPS resources in the time window.

S5. The method of solution S1, further comprising receiving, subsequent to receiving the activation indication, update information, wherein the update information comprises a downlink control information (DCI) indicating an addition or a release of one or more SPS resources or a Radio Resource Control (RRC) Reconfiguration information.

S6. A method of wireless communication, comprising transmitting, by a network node to a wireless device, a configuration of a pre-configured group of semi-persistent scheduling (SPS) resources with a bundling relationship.

S7. The method of solution S6, wherein the bundling relationship comprises a subset of the pre-configured group of SPS resources for a same service within a time window in a transmission cycle, a subset of the pre-configured group of SPS resources for a same logical channel, or a subset of the pre-configured group of SPS resources for the same service.

S8. The method of solution S6, further comprising transmitting an activation indication for at least one resource of the pre-configured group of SPS resources, transmitting, subsequent to transmitting the activation indication, a deactivation indication for one or more SPS resources in a time window, and releasing, based on the deactivation indication, the one or more SPS resources in the time window.

S9. The method of solution S6, further comprising transmitting, to the wireless device, a transmission in one or more SPS resources, wherein the wireless device is configured to release some or all other SPS resources in a time window.

S10. The method of solution S6 further comprising transmitting, subsequent to transmitting the activation indication, update information, wherein the update information comprises a downlink control information (DCI) indicating an addition or a release of one or more SPS resources or a Radio Resource Control (RRC) Reconfiguration information.

S11. The method of any of solutions S1 to S10, wherein the deactivation indication comprises an indication of a start position of the one or more SPS resources, or wherein the indication comprises a hybrid automatic repeat request (HARD) process number or index number.

S12. The method of solution S5 or S10, wherein the network node is configured to determine that a value of a burst spread associated with a wireless channel between the network node and the wireless device has changed.

S13. A method of wireless communication, comprising determining, by a network node, a propagation delay of a wireless channel between the network node and a wireless device, and transmitting, to the wireless device, a value based on the propagation delay.

S14. The method of solution S13, wherein conditions for transmitting the value based on the propagation delay meet at least one of the following (i) identifying that the wireless device needs to perform a propagation delay compensation operation, (ii) an initial access operation by the wireless device, (iii) a difference between a current measured value and a previous updated value being greater than a certain threshold, or (iv) receiving a request for reference time information from the wireless device.

S15. The method of solution S13 or S14, wherein determining the propagation delay is based on performing a round trip time (RTT) measurement, a measurement performed using a large subcarrier spacing, or a measurement performed using a subcarrier spacing for transmitting service information.

S16. A method of wireless communication, comprising receiving, by a wireless device from a network node, a value based on a propagation delay of a wireless channel between the network node and a wireless device, and performing, based on the value of the propagation delay, a propagation delay compensation operation.

S17. The method of any of solutions S13 to S16, wherein the value based on the propagation delay comprises at least one of an updated timing advance (TA) value, a TA value with a lower granularity, a propagation delay compensation value, and a valid TA value with a large subcarrier spacing.

S18. The method of any of solutions S13 to S17, wherein the value based on the propagation delay is included in a medium access control (MAC) control element (CE) or a user equipment assistance information (UEAI) message.

S19. The method of any of solutions S13 to S17, wherein the value of the propagation delay comprises (i) only an absolute value of the propagation delay, or (ii) a first value corresponding to the absolute value of the propagation delay and a second value corresponding to a relative value of the propagation delay.

S20. The method of any of solutions S13 to S19, wherein a granularity of a measurement of the propagation delay is fixed or variable.

S21. The method of solution S20, wherein a fixed granularity includes a value in nanoseconds or a timing advance (TA) value corresponding to a predefined subcarrier spacing (SCS) multiplied by a value of a factor.

S22. The method of solution S20, wherein the variable granularity includes a granularity group comprising multiple values in nanoseconds or a granularity group determined by multiplying timing advance (TA) values corresponding to a predefined subcarrier spacing (SCS) by a value of a factor.

S23. The method of solution S21 or S22, wherein the predefined SCS is 15 kHz.

S24. The method of solution S21 or S22, wherein the factor is ½, ¼, ⅛, or 1/16.

S25. The method of any of solutions 51 to S24, wherein the network node is a gNodeB (gNB) and the wireless device is a user equipment (UE).

S26. A wireless communications apparatus comprising a processor, wherein the processor is configured to implement a method recited in any of solutions S1 to S25.

S27. A computer program product comprising a computer-readable program medium code stored thereupon, the code, when executed by a processor, causing the processor to implement a method recited in any of solutions S1 to S25.

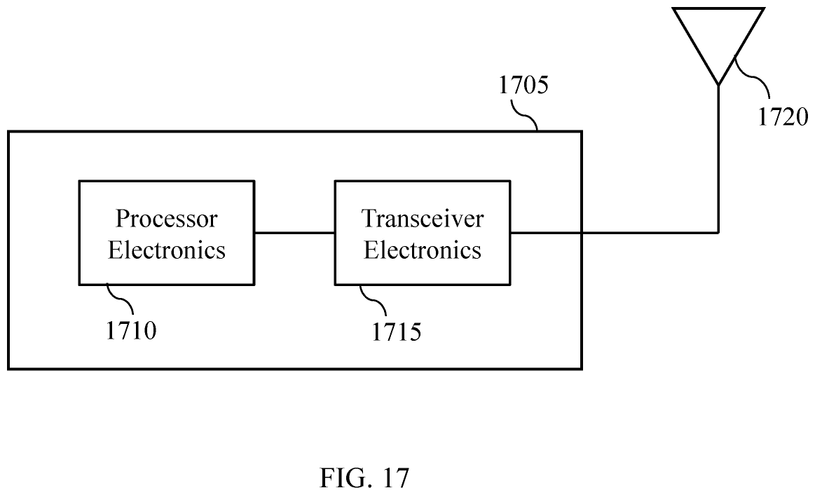

FIG. 17 is a block diagram representation of a portion of an apparatus, in accordance with some embodiments of the presently disclosed technology. An apparatus 1705, such as a base station or a wireless device (or UE), can include processor electronics 1710 such as a microprocessor that implements one or more of the techniques presented in this document. The apparatus 1705 can include transceiver electronics 1715 to send and/or receive wireless signals over one or more communication interfaces such as antenna(s) 1720. The apparatus 1705 can include other communication interfaces for transmitting and receiving data. Apparatus 1705 can include one or more memories (not explicitly shown) configured to store information such as data and/or instructions. In some implementations, the processor electronics 1710 can include at least a portion of the transceiver electronics 1715. In some embodiments, at least some of the disclosed techniques, modules or functions are implemented using the apparatus 1705.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
determining, by a network node, a propagation delay of a wireless channel between the network node and a wireless device;
receiving, by the network node from the wireless device, a request for reference time information, wherein the request is included in a UE Assistance Information (UEAI) message; and
in response to receiving the request, transmitting, by the network node to the wireless device, a value based on the propagation delay and an indication whether to perform a propagation delay compensation operation.

2. The method of claim 1, wherein the value is a timing advance value, and wherein the timing advance value enables the wireless device to perform the propagation delay compensation operation based on the timing advance value.

3. The method of claim 1, wherein the indication whether to perform the propagation delay compensation operation is transmitted through a downlink information transfer message.

4. The method of claim 1, wherein the value based on the propagation delay is included in a medium access control (MAC) control element (CE).

5. The method of claim 1, wherein the network node is a gNodeB (gNB) and the wireless device is a user equipment (UE).

6. A method of wireless communication, comprising:
transmitting, by a wireless device to a network node, a request for reference time information, wherein the request is included in a UE Assistance Information (UEAI) message;
in response to transmitting the request, receiving, by the wireless device from the network node, a value based on a propagation delay of a wireless channel between the network node and the wireless device;
receiving an indication whether to perform a propagation delay compensation operation; and
performing, based on the value of the propagation delay, the propagation delay compensation operation.

7. The method of claim 6, wherein the value is a timing advance value, and wherein the wireless device performs the propagation delay compensation operation based on the timing advance value.

8. The method of claim 6, wherein the indication whether to perform the propagation delay compensation operation is received through a downlink information transfer message.

9. The method of claim 6, wherein the value based on the propagation delay is included in a medium access control (MAC) control element (CE).

10. The method of claim 6, wherein the network node is a gNodeB (gNB) and the wireless device is a user equipment (UE).

11. An apparatus for wireless communication comprising a processor and a memory storing instructions, execution of which by the processor causes the apparatus to:
determine a propagation delay of a wireless channel between the apparatus and a wireless device;
receive, from the wireless device, a request for reference time information, wherein the request is included in a UE Assistance Information (UEAI) message; and
in response to receiving the request, transmit, to the wireless device, a value based on the propagation delay and an indication whether to perform a propagation delay compensation operation.

12. The apparatus of claim 11, wherein the value is a timing advance value, and wherein the timing advance value enables the wireless device to perform the propagation delay compensation operation based on the timing advance value.

13. The apparatus of claim 11, wherein the indication whether to perform the propagation delay compensation operation is transmitted through a downlink information transfer message.

14. The apparatus of claim 11, wherein the value based on the propagation delay is included in a medium access control (MAC) control element (CE).

15. The apparatus of claim 11, wherein the apparatus is a gNodeB (gNB) and the wireless device is a user equipment (UE).

16. An apparatus for wireless communication comprising a processor and a memory storing instructions, execution of which by the processor causes the apparatus to:
transmit, to a network node, a request for reference time information, wherein the request is included in a UE Assistance Information (UEAI) message;
in response to transmitting the request, receive, from the network node, a value based on a propagation delay of a wireless channel between the network node and the apparatus;
receive an indication whether to perform a propagation delay compensation operation; and
perform, based on the value of the propagation delay, the propagation delay compensation operation.

17. The apparatus of claim 16, wherein the value is a timing advance value, and wherein the apparatus performs the propagation delay compensation operation based on the timing advance value.

18. The apparatus of claim 16, wherein the indication whether to perform the propagation delay compensation operation is received through a downlink information transfer message.

19. The apparatus of claim 16, wherein the value based on the propagation delay is included in a medium access control (MAC) control element (CE).

20. The apparatus of claim 16, wherein the network node is a gNodeB (gNB) and the apparatus is a user equipment (UE).
